(19) United States
(12) Patent Application Publication
(10) Pub. No.: US 2017/0028595 A1
(43) Pub. Date: Feb. 2, 2017

(54) Pure Layered Stretch Film Produced Using Single Pass Extrusion Resins

(71) Applicant: Paragon Films, Inc., Broken Arrow, OK (US)

(72) Inventor: Michael John Baab, Tulsa, OK (US)

(73) Assignee: Paragon Films, Inc., Broken Arrow, OK (US)

(21) Appl. No.: 15/224,937

(22) Filed: Aug. 1, 2016

Related U.S. Application Data
(60) Provisional application No. 62/199,152, filed on Jul. 30, 2015.

(51) Int. Cl. B29C 39/20; B29C 69/00; B29C 39/38; B29C 39/26; B29C 39/24

(52) U.S. Cl. CPC B29C 39/203; B29C 39/26; B29C 39/24; B29C 39/38; B29C 69/001; B29L 2007/008

(57) ABSTRACT

Methods for producing a stretch film are provided, including disposing one or more extruders in fluid communication with a stock of virgin resin; heating the virgin resin to a molten state; delivering the molten virgin resin to a die; and extruding the molten virgin resin through the die onto a casting roll, thereby creating a cast stretch film. Methods for delivering the molten virgin resin onto a casting roll of varying sizes and set temperatures; and of moving a resulting film onto a secondary chill roll of varying sizes and set temperatures, are also provided. Finally, methods for moving the film from either the casting roll or the secondary chill roll onto a slitting assembly, dividing the film using one more interior or exterior slits, and then capturing and gathering the trim waste but not reintroducing the trim waste back into the production process are also disclosed.

### FIELD

The present invention relates generally to high-quality, durable, flexible stretch films, and in a specific though non-limiting embodiment, to a stretch film produced from virgin resins introduced into a single pass extrusion process without prior, subsequent or contemporaneous introduction of reprocessed film material such as edge trim or center trims and/or repellitized material. The resulting film provides a finished product containing a plurality of polymer layers having only a single heat history.

### BACKGROUND

In the cast stretch film process, when a molten web exits a die, the edges of the web draw in towards the center of the die due to inherent melt tension of the polymers and the relaxation of the web in the molten state. This phenomenon is commonly referred to as “neck-in.”

Stretch film producers are typically required to remove this effected region of the web (usually a minimum of 4-5 inches) in order to make the film as uniform as possible in thickness across the web. In general, the more uniform the web, the better the roll geometry and conformity. Poor roll geometry affects the ability of the roll to unwind uniformly and stretch to a prescribed level, and increases the chance of film failure when it is stretched or applied to a load.

In cast stretch film production operations, the neck-in material, along with any center trims (film removed between the adjoining rolls), is sent to either a grinder or a repellitizer. This material typically accounts for as much as 20% of the total output of production lines. Currently, all known commercial cast stretch film producers re-introduce this material back into the process in order to reduce costs and make production of the film commercially viable.

The vast majority of film producers convert the trimmed material to “fluff” (by chopping the film ribbon into small pieces), and then re-inserting the fluff back into a larger extruder, where it is combined in a special compacting hopper with resin pellets before entering the feed throat of the extruder.

The fluff can also be sent to an auxiliary compounding extruder to be converted into what is generally referred to as reprocensed pellets or “repro.” Some facilities have the ability to send the edge trim directly to a repelletizing extruder and then return the repro back to the line for re-introduction to the process.

In each of the aforementioned operations, the resulting reprocessed material is of a lesser quality than the virgin resins because the repro is a blend of all of the resins in the film. When the reprocessed resins are blended with the virgin resins of a discrete layer of the film, the desired film properties are negatively impacted. The blending of reprocessed resin into virgin products may be acceptable for lower grade films, but it has the potential to significantly degrade the performance characteristics of higher grade films.

One of the negative effects associated with the blending of reprocessed material is that the reprocessed material introduces multiple heat and shear histories. Due to the high temperatures required in the cast stretch film process (often greater than 500° F./260° C. or more), multiple pass extrusion results in a significant degradation of the polymers due to oxidation, crosslinking, and chain scission.

Other defects associated with these degraded products are gelling, die lip build-up, clogged flow lines, and incidental production of carbon. For example, when film is produced on a typical commercial stretch film production line under steady state extrusion conditions, a trim return of around 18% per iteration yields multiple heat/shear histories in the following percentages:
First pass—18%
Second pass—3.24%
Third pass—0.58%
Fourth pass—0.10%
Fifth pass—0.02%

Due to the potential for contamination while handling of the trimmed film, the reprocessed material is less flexible, less durable, and of a lower grade than films produced using only virgin resins.

There is, therefore, a long-standing yet unmet need for high-grade stretch films having improved flexibility and durability, and improved methods of manufacturing the same.

### SUMMARY

In one embodiment, a method for producing a cast stretch film is provided, the method including at least: disposing one or more extruders in fluid communication with a stock of virgin resin; heating the virgin resin to a molten state; delivering the molten virgin resin to a die; and extruding the molten virgin resin through the die onto a casting roll, thereby creating a cast stretch film.

In other embodiments, the method includes delivering the molten virgin resin to a die via one or more transfer pipes.

In further embodiments, the method includes one or more of: moving the resin from the die onto a casting roll; moving the resin from the die onto a matte casting roll; moving the resin from the die onto an approximately 30-inch matte casting roll; moving the resin from the die onto a casting roll having a set temperature; moving the resin from the die onto a casting roll having a set temperature between about 75° F. and about 100° F.; and moving the resin from the die onto a casting roll having a set temperature of about 90° F.

In still further embodiments, the method includes one or more of: moving the resulting film from the casting roll onto a secondary chill roll; moving the film from the casting roll onto an approximately 20-inch chill roll; moving the film from the casting roll to a secondary chill roll having a set temperature; moving the film from the casting roll to a secondary chill roll having a set temperature between about 65° F. and about 90° F.; and moving the film from the casting roll to a secondary chill roll having a set temperature of about 85° F.

In further embodiments still, the method includes one or more of: moving the film from the casting roll onto a slitting assembly; using the slitting assembly to form one or more interior slits, thereby creating waste film that is not recycled back into the production process; and using the slitting assembly to form one or more exterior slits, thereby creating waste film that is not recycled back into the production process.

In yet other embodiments, the method includes one or more of: moving the film from the secondary chill roll onto a slitting assembly; using said slitting assembly to form one or more interior slits, thereby creating waste film that is not recycled back into the production process; and using said slitting assembly to form one or more exterior slits, thereby creating waste film that is not recycled back into the production process.

In still other embodiments, the method includes one or more of: omitting the introduction of any waste material into the virgin resin prior to the melting and extruding processes; and omitting the introduction of any waste material into the virgin resin during the melting and extruding processes.

### BRIEF DESCRIPTION OF THE DRAWINGS

For a further understanding of the nature, objects, and advantages of the present invention, reference should be made to the followed description, read in conjunction with the following drawings, wherein like reference numerals denote like elements and wherein:

FIG. 1 illustrates the steps for producing cast stretch films in-process according to one embodiment of the present invention; and

FIG. 2 illustrates a means for producing cast stretch films according to one embodiment of the present invention.

### DETAILED DESCRIPTION

The following detailed description is not limiting, but offered merely for the purpose of illustrating several example embodiments.

The ability to produce films utilizing only single pass extrusion provides significant improvement in performance properties by removing the blended resins that are reintroduced into single pass virgin resin layers, while also reducing many of the defects associated with reprocessed material due to crosslinking, oxidation, and contamination.

Note that for purposes of this application, the term “virgin resin” comprises a resin that is not blended, processed prior to extrusion in conjunction with, or otherwise contaminated by reprocessed waste resins.

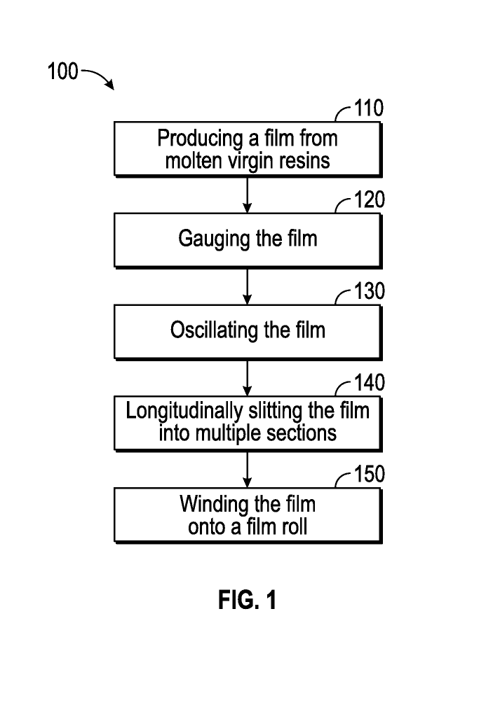

Referring generally to FIG. 1, the steps 100 for producing a cast stretch film according to one aspect of the invention are illustrated. Specifically, the steps comprise producing a film from molten virgin resins 110, gauging the film 120, oscillating the film 130, longitudinally slitting the film into multiple sections 140, and winding the film onto a film roll 150. In some embodiments, all of the steps are performed along a single production line. However, it is also contemplated that the steps can be performed in a different order, and steps may be added or eliminated without departing from the scope of the claims below. In any event, waste and trim film is not reprocessed back into first step 110.

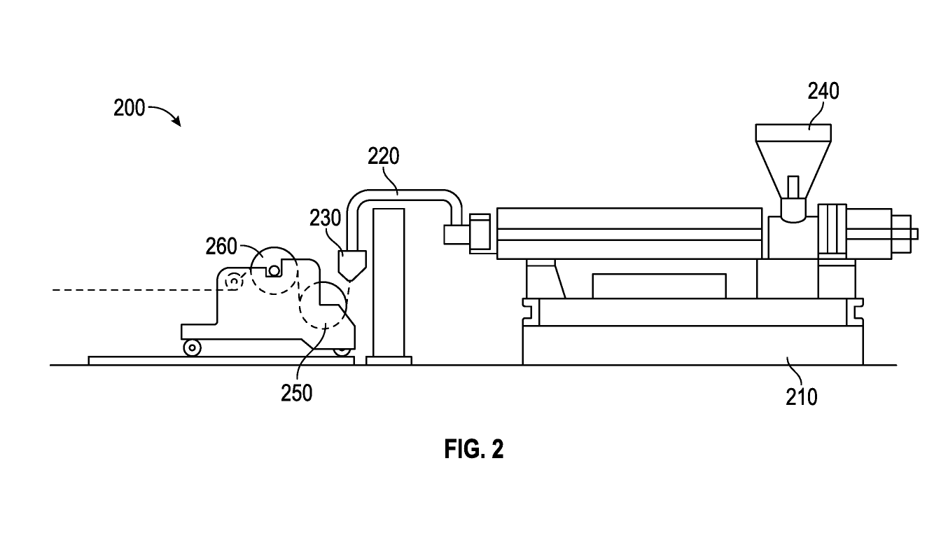

As shown in FIG. 2, a means for producing a cast stretch film from molten virgin resins 200 comprises one or more extruders 210 connected by transfer pipes 220 to a die 230. The number of extruders 210 used in the apparatus depends upon the desired composition of the film.

For example, to produce a three-layer film, three extruders 210 are used. In another example embodiment, to produce a five-layer film, three, four, or even five extruders 210 are used.

According to other example embodiments, the extruders 210 are connected to a source 240 of stock virgin resin. The extruders 210 heat the stock virgin resin to a molten state and deliver the molten virgin resin to the die 230 through the transfer pipes 220. In example embodiments, the film is extruded through the die 230 onto a casting roll 250. In further example embodiments, the casting roll 250 is a 30-inch diameter matte casting roll having a set temperature. In still further example embodiments, the set temperature of the casting roll ranges from about 75° F. to 100° F.; in a presently preferred embodiment the casting roll has a set temperature of about 90° F.

In other example embodiments, the film moves from the casting roll 250 to a secondary chill roll 260. According to example embodiments, the secondary chill roll is a 20-inch diameter mirror finish secondary chill roll with a set temperature. As a further example embodiment, the set temperature of the secondary chill roll ranges from about 65° F. to 90° F., with a preferred value of about 85° F.

In some embodiments, the film is then passed from the caster roll or the chiller roll to a slitting assembly. Since slitting assemblies are generally known in the art, the present disclosure comprises any previously known slitting assembly (or any other similarly functioning slitting assembly subsequently devised) used to slit the film into multiple sections, for example, into one or more interior slit sections and one or more exterior slit sections.

An interior slit is defined as a slit made somewhere within the original width of film, thereby resulting in multiple sections of lesser width. For example, if a sheet of film is divided using a single internal slit, two smaller sheets of approximately one-half the width of the original sheet width will be created. In so dividing the sheet, film waste may be created that can be captured and gathered together with additional film waste in order to create a supply of reprocessed resin that can later be molten into the resin supply subsequently extruded by the die.

An exterior slit is defined as a slit made along one of the edges of the original width of film. So, even if a sheet is not divided by a slitter, at least two exterior slits are still possible, viz., one on either side of the film sheet. if a sheet is divided one or more times, additional exterior slits may result as each new subsection of the sheet again comprises two external edges. In any event, any film trimmed during the exterior slitting process is typically gathered and added to other such waste for reprocessing into the production line during the melting of the resin feed stage.

In stark contrast to the prior art, however, at no point in the process claimed herein is the molten virgin resin blended, processed in conjunction with, or otherwise contaminated by any reprocessed waste or trim resins obtained from either the casting process or from an external source. In other words, neither the waste captured and gathered during a given process run nor waste previously obtained or combined with similar waste from other, external sources, is ever used in the melting and extruding stage or at any other time during production. By avoiding this step, stretch film is obtained having important improvements over films made using the reprocessing methods of the prior art.

For example, through detailed experimentation it has been shown that defects in a film resulting from gel formation attributable to reprocessed waste film can be approximately halved by using only virgin resin materials in the process run. Since the mentioned gel formations are deleterious to the stability of the film and cause film failure under stress loads, such defects are to be avoided or minimized where possible.

In one experiment in which a stretch film run of approximately 7,000 feet having a width of approximately 15 inches, the defect rate as measured by gel formation in the resulting stretch film was 28,301 gel formations of various sizes identified within the specimen, or 3.22654 total instances of gel formation per square foot. In contrast, in a competing run of the same dimensions in which only virgin film was processed, the defect rate as measured by gel formation in the resulting stretch film was 13,865 gel formations of various sizes identified within the specimen, or 1.581014 total instances of gel formation per square foot.

This analysis demonstrates that by using only virgin film in the process run, and by eliminating the addition of any reprocessed film, instances of both gel formations of various sizes and total gel formations within the specimen on a per square foot basis are more than halved. Since the gel formation can be directly responsible for film failure under stress loads, the resulting film produced using only virgin materials is demonstrably superior.

A great many other advantages and variations of the instant disclosure will readily occur to ordinarily skilled artisans, even if significant departures from the non-limiting disclosure of structures and operations described herein are practiced. Nowhere in the prior art, whether considered alone or in combination, is a pure layered stretch film produced using single pass virgin resins previously known or used to create durable, flexible, high-grade industrial stretch films.

The foregoing specification is provided for illustrative purposes only, and is not intended to describe all possible aspects of the present invention. Moreover, while the invention has been shown and described in detail with respect to several exemplary embodiments, those of ordinary skill in the relevant arts will appreciate that minor changes to the description, and various other modifications, omissions and additions may also be made without departing from either the spirit or scope thereof.

1. A method for producing a cast stretch film, said method comprising: disposing one or more extruders in fluid communication with a stock of virgin resin; heating said virgin resin to a molten state; delivering said molten virgin resin to a die; and extruding said molten virgin resin through said die onto a casting roll, thereby creating a cast stretch film.

2. The method of claim 1, further comprising delivering said molten virgin resin to a die via one or more transfer pipes.

3. The method claim 1, further comprising moving said resin from the die onto a matte casting roll.

4. The method of claim 3, further comprising moving said resin from the die onto a matte casting roll, wherein said matte casting roll is an approximately 30-inch matte casting roll.

5. The method of claim 1, further comprising moving said resin from the die onto a casting roll having a set temperature.

6. The method of claim 5, further comprising moving said resin from the die onto a casting roll having a set temperature between about 75° F. and about 100° F.

7. The method of claim 6, further comprising moving said resin from the die onto a casting roll having a set temperature of about 90° F.

8. The method of claim 1, further comprising moving the film from said casting roll to a secondary chill roll.

9. The method of claim 8, further comprising moving the film from said casting roll to a secondary chill roll, wherein said secondary chill roll is an approximately 20-inch chill roll.

10. The method of claim 8, further comprising moving the film from said casting roll to a secondary chill roll having a set temperature.

11. The method of claim of claim 10, further comprising moving the film from said casting roll to a secondary chill roll having a set temperature between about 65° F. and about 90° F.

12. The method of claim 11, further comprising moving the film from said casting roll to a secondary chill roll having a set temperature of about 85° F.

13. The method of claim 1, further comprising moving the film from the casting roll onto a slitting assembly.

14. The method of claim 13, further comprising using said slitting assembly to form one or more interior slits, thereby creating waste film that is not recycled back into the production process.

15. The method of claim 13, further comprising using said slitting assembly to form one or more exterior slits, thereby creating waste film that is not recycled back into the production process.

16. The method of claim 8, further comprising moving the film from the secondary chill roll onto a slitting assembly.

17. The method of claim 16, further comprising using said slitting assembly to form one or more interior slits, thereby creating waste film that is not recycled back into the production process.

18. The method of claim 16, further comprising using said slitting assembly to form one or more exterior slits, thereby creating waste film that is not recycled back into the production process.

19. The method of claim 1, further comprising omitting the introduction of any waste material into the virgin resin prior to the melting and extruding processes.

20. The method of claim 1, further comprising omitting the introduction of any waste material into the virgin resin during the melting and extruding processes.
